(19) United States
(12) Patent Application Publication
(10) Pub. No.: US 2007/0268579 A1
(43) Pub. Date: Nov. 22, 2007

(54) METHODS AND APPARATUSES FOR STEREOGRAPHIC DISPLAY

(75) Inventor: Guang Yang, Singapore (SG)

Correspondence Address: ACIST MEDICAL SYSTEMS, INC., IP DEPT., 7905 FULLER ROAD, EDEN PRAIRIE, MN, 55344, US

(73) Assignee: Bracco Imaging SPA, Milano (IT)

(21) Appl. No.: 11/419,189

(22) Filed: May 18, 2006

(51) Int. Cl. G02B 27/22

(52) U.S. Cl. 359/462

(57) ABSTRACT

Methods and apparatuses for stereographic display using a filter structure. One embodiment includes a filter layer having: a first plurality of filter strips arranged in parallel with viewing directions from a first viewing position, and a second plurality of filter strips arranged in parallel with viewing directions from a second viewing position. Another embodiment includes determining a location of an observer; and adjusting a filter structure relative to the observer according to the determined location of the observer.

### TECHNOLOGY FIELD

At least some embodiments of the present disclosure relate to the display of stereoscopic images.

### BACKGROUND

A stereograph provides a pair of images, each for one of the eyes of an observer, such that the observer can have a sense of depth when viewing the pair of images.

Many techniques have been developed to present the pair of images of a stereoscopic view so that each of the eyes of an observer can see one of the pair of images to obtain a three-dimensional effect. The images can be presented to the eyes separately using a head mounted display. The images can be presented at the same location (e.g., on the same screen) but with different characteristics, such that viewing glasses can be used to select the corresponding image for each of the eyes of the observer.

For example, the pair of images can be presented with different timing, and liquid crystal shutter glasses can be used to select the images for the corresponding eyes. By further example, the pair of images can be presented with differently polarized lights, and polarized glasses with corresponding polarizing filters can be used to select the images for the corresponding eyes. For example, the pair of images can be pre-filtered with color filters and combined as one anaglyph image, and anaglyph glasses with corresponding color filters can be used to select the images for the corresponding eyes.

When a pair of shutter glasses is used, the pair of images can be displayed in an alternating sequence (e.g., in a method called page flipping stereo) on a computer or video screen, such as a cathode-ray tube (CRT) screen (or a liquid crystal display (LCD) screen). When even numbered frames are shown on the screen (e.g., frames 0, 2, 4, 6, etc.), the screen displays images intended for the viewer's left eye to see, and the left shutter on the shutter glasses turns transparent while the right shutter on the glasses turns opaque. Thus, the left eye sees the screen during the even numbered frames; and the right eye does not. When odd numbered frames are shown on the screen (e.g., frames 1, 3, 5, 7, etc.), the screen displays images intended for the viewer's right eye to see, and the right shutter on the shutter glasses turns transparent while the left shutter on the glasses turns opaque. Thus, the right eye sees the screen during odd numbered frames, and the left eye does not. This order could be reversed, so the right eye can be made to view even numbered frames and the left eye can view odd numbered frames. Viewing alternating frames with alternating left and right eyes in synchronization with the display of image frames allows the left and right eyes to see the left and right images respectively for a three-dimensional effect.

Alternatively, the pair of images can be displayed or printed in a side by side format for viewing, with or without the use of any additional optical equipment. An observer can cause the eyes to cross or diverge so that each of the eyes sees a different one of the pair of images to obtain a sense of depth, without using any additional optical equipment.

Therefore, a need exists for a less cumbersome method and system for a viewer to view a stereographic display.

### SUMMARY OF THE DESCRIPTION

Methods and apparatuses for stereographic display using a filter structure are described herein. Some embodiments are summarized in this section.

One embodiment includes a filter layer having a first plurality of filter strips arranged in parallel with viewing directions from a first viewing position, and a second plurality of filter strips arranged in parallel with viewing directions from a second viewing position.

Another embodiment includes determining a location of an observer; and adjusting a filter structure relative to the observer according to the determined location of the observer.

The present disclosure includes methods and apparatuses which perform these methods, including data processing systems which perform these methods, and computer readable media which when executed on data processing systems cause the systems to perform these methods.

Other features will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 illustrates a filter structure for stereographic display according to one embodiment.

FIG. 2 illustrates the arrangement of filter strips with respect to two viewing positions according to one embodiment.

FIGS. 3-4 illustrate the filtering for different viewing positions by different sets of filter strips according to one embodiment.

FIG. 5 illustrates an arrangement of filter strips for stereographic display according to an alternative embodiment.

FIG. 6A illustrates an arrangement in which the filter strips can extend beyond contact points between neighboring filter strips according to one embodiment.

FIG. 6B illustrates an example of a system for adjusting a filter structure according to one embodiment.

FIG. 6C illustrates an example of a system for adjusting a display assembly according to one embodiment.

FIG. 7 illustrates a further alternative arrangement of filter strips for stereographic display according to one embodiment.

FIG. 8 illustrates a method to control the arrangement of a filter structure according to one embodiment.

FIG. 9 shows a block diagram example of a data processing system for controlling the arrangement of a filter structure according to one embodiment.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description. References to one or an embodiment in the present disclosure can be, but not necessarily are, references to the same embodiment; and, such references mean at least one.

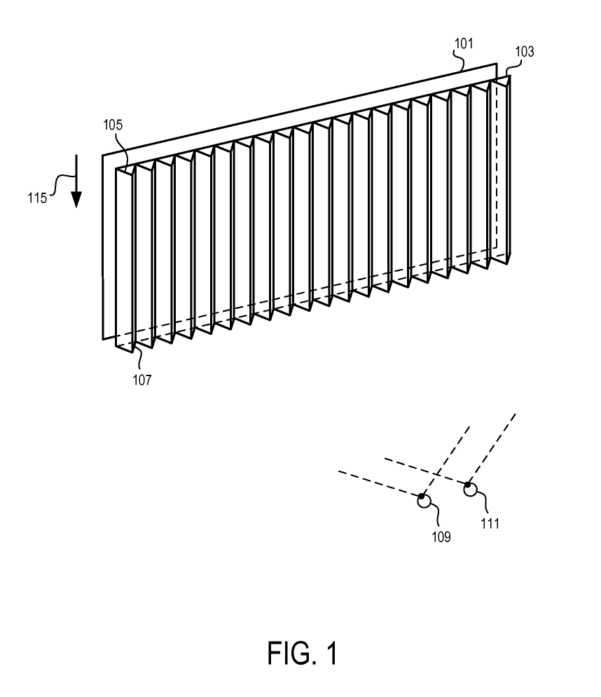

FIG. 1 illustrates a filter structure for stereographic display according to one embodiment. In FIG. 1, a display system includes an image display screen (101) and a filter layer (103) disposed between the eyes (109 and 111) of a viewer and the screen (101). The filter layer (103) can be disposed over the screen (101) (e.g., like a cover of the screen) or placed between the screen and the viewer (e.g., like a curtain).

In FIG. 1, the filter layer (103) includes two sets of filter strips. One set of filter strips (e.g., 105) are generally parallel with the viewing directions from the right eye (e.g., 111) (approximately or exactly, within design and/or manufacturing tolerances and/or image quality requirements); and the other set of filter strips (e.g., 107) are generally parallel with the viewing directions from the left eye (e.g., 109) (approximately or exactly, within design and/or manufacturing tolerances and/or image quality requirements).

For the point of view of one eye, one of the two sets of the filter strips are parallel with the viewing directions from the eye. Thus, the parallel set of filter strips appear as separate lines in this eye. If the strips are thin enough, the appearance against the bright display screen would be less obvious and can be ignored. This eye sees the scene behind the filter layer predominantly through the non-parallel set of strips. The parallel set of strips for one eye is the non-parallel set of strips for the other eye. Thus, the two eyes see the scene as displayed on the screen (101) separately through the two different sets of filter strips.

In one embodiment, the two different sets of the filter strips are used to selectively filter the light coming from the screen (101) separately for the left and right eyes (109 and 111) of the observer, so that the left and right eyes can see the left and right images of a stereograph display when viewing the screen (101) through the filter layer (103).

In one embodiment, the screen (101) shows a stereograph display of left and right images according to an alternating sequence. The two sets of filter strips are switchable between transparent and opaque.

When the image for the left eye is displayed on the screen (101), the set of filter strips (e.g., 107) that are parallel to the viewing directions from the left eye are switched to opaque to block the right eye's view to the screen. The other set of filter strips (e.g., 105) are switched to transparent to allow the left eye to see the image for the left eye. Although the lines of the image that are projected from the parallel, opaque set of filter strips (e.g., 107) along the viewing directions from the left eye are blocked, the remaining portions of the image are visible to the left eye.

Similarly, when the image for the right eye is displayed on the screen (101), the set of filter strips (e.g., 107) that are parallel to the left eye are switched to transparent to unblock the view to the right eye, allowing the right eye to see the image displayed for the right eye. The other set of filter strips (e.g., 105) are switched to opaque to block the left eye's view to the screen. Although the lines of the image that are projected from the opaque set of filter strips (e.g., 105) along the viewing directions from the right eye are blocked, the remaining portions of the image are visible to the right eye.

Thus, the left and right eyes can see the corresponding left and right images in an alternating fashion, through the selective filtering by the filter layer (103). In one embodiment, the filter strips are made of liquid crystal (LC) shutter strips. The operations of the shutter strips are synchronized with the alternating display of the left and right images of stereographs.

Alternatively, left and right images of a stereograph can be combined and presented as an anaglyph image. For example, the left and right images can be pre-filtered with different colors (e.g., red and cyan) and then superposed to generate a stereoscopic anaglyph image. The anaglyph image can be displayed on the screen (101). The two sets of filter strips with corresponding color filtering capabilities can be used to filter the anaglyph image accordingly for the left and right eyes and thus to allow the left and right eyes to see the left and right images respectively.

Alternatively, left and right images of a stereograph can be displayed with lights of different polarities. For example, the left and right images can be filtered with orthogonal polarizing filters and superposed to generate a stereograph display on the screen (101). The two sets of filter strips with corresponding orthogonal polarizing filters can be used to filter the combined image to allow the left and right eyes to see the left and right images respectively. Alternatively, circular polarizing filters can be used.

In various embodiments, the screen (101) can be any of a number of suitable screens, such as but not limited to a cathode-ray tube (CRT) or liquid crystal display (LCD) monitor. The filter layer (103) can be disposed over the screen (101) at any suitable distance and in any suitable manner in accordance with the teachings herein.

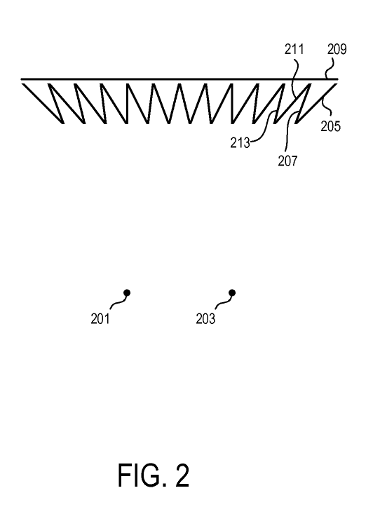

FIG. 2 illustrates the arrangement of filter strips with respect to two viewing positions according to one embodiment. FIG. 2 shows a top view of the arrangement of the filter strips along a viewing direction parallel to the screen and the filter strips (e.g., direction 115 in FIG. 1).

With reference to FIGS. 2 to 4, the filter layer includes a set of filter strips (e.g., 205, 211) that are parallel with the viewing directions from the left position (201) and a set of filter strips (e.g., 207, 213) that are generally parallel with the viewing directions from the right position (203). The display screen (209) is behind the filter layer as seen from a viewer's position. The screen image as seen from the left position (201) is predominantly filtered by the set of filter strips (e.g., 207, 213) that are parallel with the viewing directions from the right position (203). The screen image as seen from the right position (203) is predominantly filtered by the set of filter strips (e.g., 205, 211) that are parallel with the viewing directions from the left position (201).

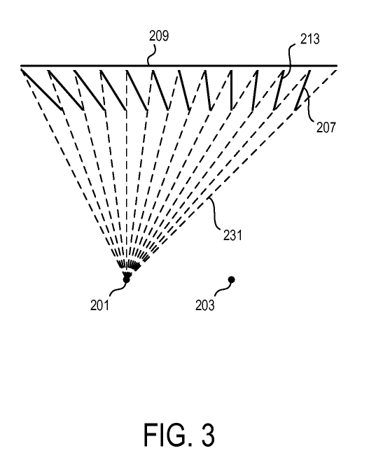

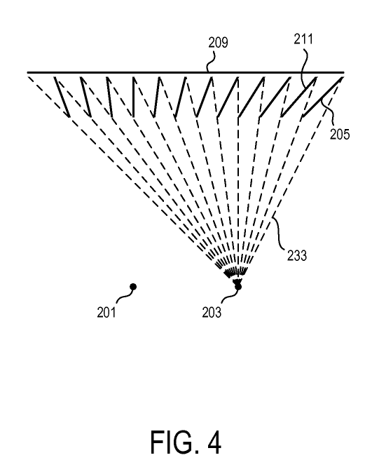

Thus, when the eyes of the observer are positioned at the left and right positions (201 and 203) respectively, the left eye of the observer sees the screen image as being filtered by the set of filter strips (e.g., 207, 213) that are parallel with the viewing directions from the right position (203); and the right eye of the observer sees the screen image as being filtered by the set of filter strips (e.g., 205, 211) that are parallel with the viewing directions from the left position (201). Such selective filtering using different sets of filter strips is further illustrated in FIGS. 3-4, which illustrate the filtering for different positions by different sets of filter strips according to one embodiment.

In FIG. 3, the screen image on the screen (209) is predominantly filtered for the left position (201) by the set of filter strips (e.g., 207, 213) that are generally parallel with the viewing directions from the right position (203). The set of filter strips that are parallel with the viewing directions from the left position (201) has little effect on the view as observed from the left position (201), except on the lines projected from the parallel set of filter strips along the viewing directions (e.g., 231) from the left position (201).

Similarly, in FIG. 4, the screen image on the screen (209) is predominantly filtered for the right position (203) by the set of filter strips (e.g., 205, 211) that are generally parallel with the viewing directions from the left position (201). The set of filter strips that are parallel with the viewing directions from the right position (203) have little effect on the view as observed from the right position (203), except on the lines projected from the parallel set of filter strips along the viewing directions (e.g., 233) from the right position (203).

Since the desired view of an image for each of the viewing positions can be obscured by the parallel set of filter strips on the lines projected from the parallel set of filter strips, it is desirable to reduce the thickness of the projection of the filter strips and the number of filter strips to minimize that artifact. When the width of the filter strips is constant, the number of filter strips can be reduced by positioning the filter layer close to the designed viewing positions. When the spacing between the designed viewing positions and the filter layer is constant, the narrower the strips, the larger is the number of strips. The thickness of the projection of the filter strips can be reduced by positioning the filter strips accurately in the viewing direction from the corresponding viewing position and by reducing the thickness of the filter strips. The width of a strip can be designed in the range from sub-millimeter to a few millimeters, or designed to cover one column or a few columns of pixels (or more) from one eye point of view.

In at least some embodiments, the orientations of the two sets of filter strips determines two positions, called sweet spots. The stereo effect can be best observed when the eyes of an observer are at the sweet spots. For example, in FIGS. 3 and 4, the filter strips are arranged to have the dotted lines converge at sweet spots 201 and 203; and the distance between the pair of sweet spots 201 and 203 is called the interocular distance or eye separation, which is approximately 65 mm. These two positions can also be called desired positions for stereoscopic viewing.

After the orientations of the filter strips are fixed, the two sweet spots are fixed. An observer is required to try to position the eyes at the sweet spots for best viewing results.

In one embodiment, a system is used to track the current positions of the observer's eyes, and then adjust the filter strips to cause the sweet spots to follow the observer's eyes, such that the observer has some freedom to move around without loosing the stereo vision.

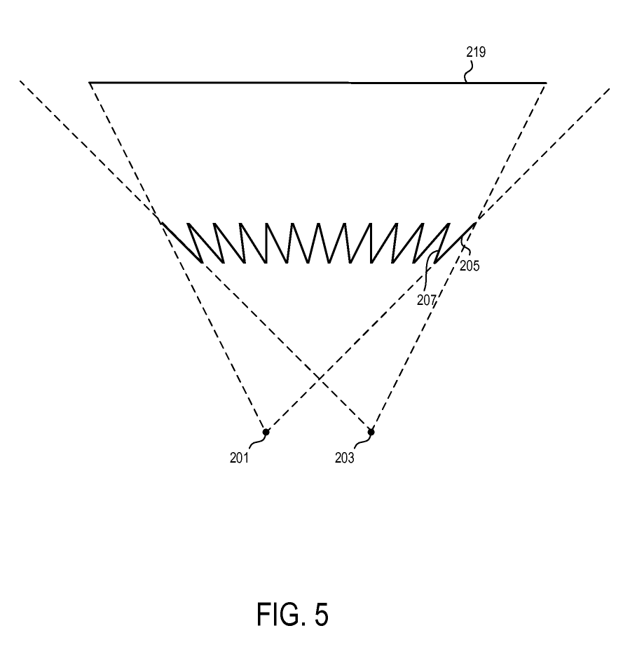

FIGS. 5-7 illustrate arrangements of filter strips for stereographic display according to alternative embodiments. FIG. 5 illustrates an arrangement in which the filter layer is position approximately half-way between the display screen (219) and the desired viewing positions (201 and 203).

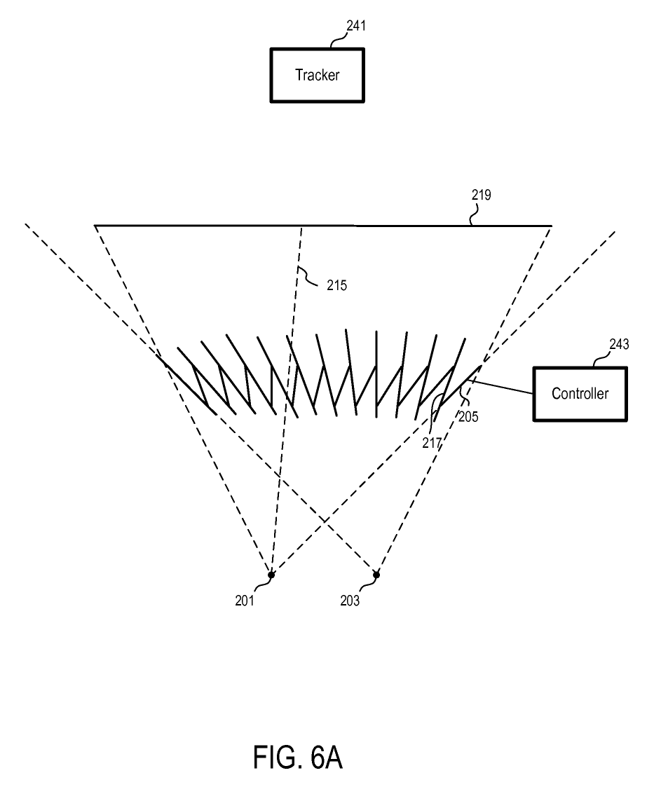

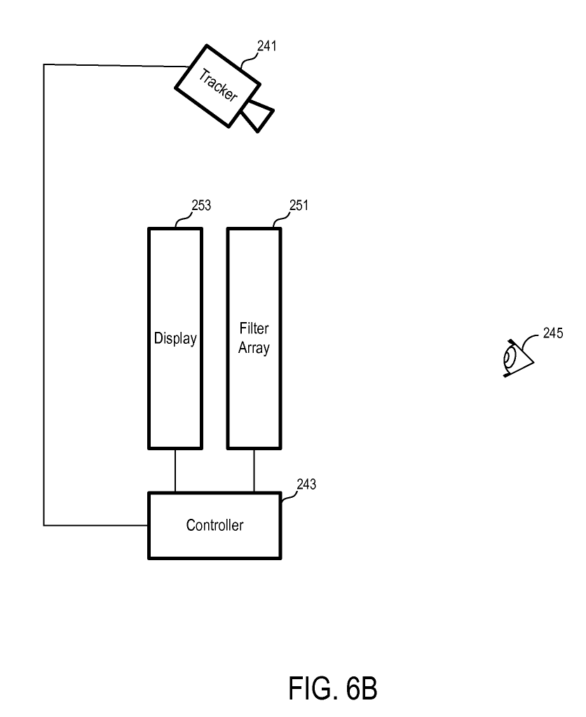

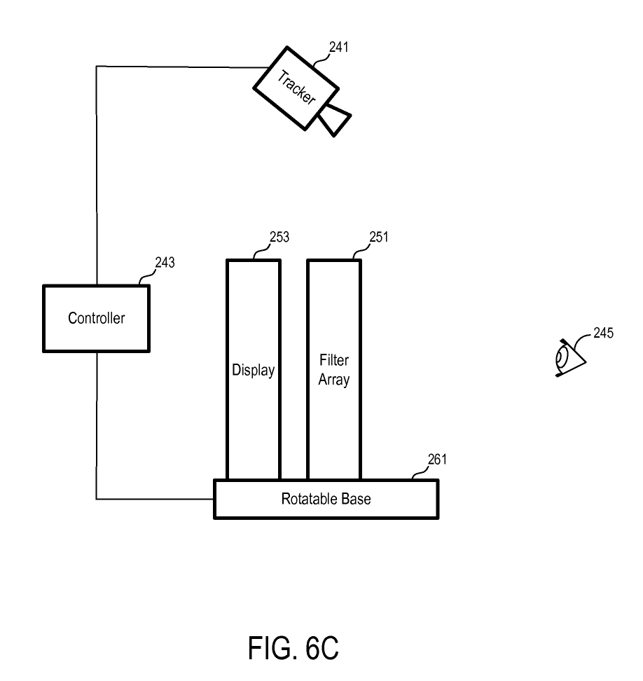

FIG. 6A illustrates an arrangement in which the filter strips can extend beyond contact points between neighboring filter strips. In such an arrangement, some lines of view directions of many be filtered by multiple layers of filter strips, such as along the view direction (215). Such an arrangement can produce acceptable results when the artifact produced by multiple layers of filtering is small. For example, when the strips are LC shutter strips with sufficient clarity when switched to a transparent state, multiple layers of filtering through transparent LC shutters can produce an acceptable result. The arrangement as illustrated in FIG. 6A allows more freedoms in repositioning the filter strips to change the converging points relative to the filter layer. A controller (243) can be used to adjust the orientations of the filter strips and/or the filter structure and/or the display (219), based on the input from a tracker (241) that is used to track the position of eyes of an observer. Thus, when a relative position and orientation between the observer and the filter layer is changed, the locations of the filter strips can be adjusted to cause the sweet spots of the filter layer to track the eyes of the observer.

As illustrated in FIG. 6B, a tracker (241) can be used to determine the location of an eye (245) of an observer. Based on the tracked location of the eye, the controller (243) determines the desired orientation of the filter array (251) and/or the desired orientations of the filter strips of the filter array (251) and adjusts the filter array (251) and/or the filter strips of the filter array (251) such that the eye (245) of an observer is at or near a sweet spot for viewing the display (253).

For example, in one embodiment, the controller (243) includes a set of electromechanical elements each of which can be individually controlled to adjust the orientations of the filter strips; thus, the converging points (201 and 203) as defined by the orientations of the filter strips follow the positions of the eyes of the observer. This allows the sweet spots of the display assembly to be adaptively adjustable to the tracked location of the observer.

Alternatively, the display assembly can be moved together, as illustrated in FIG. 6C. A rotatable base (261) can be used to move the display assembly, including the display (253) and the filter array (251), based on the location of the eye (245) as tracked by the tracker (241) and under the control of the controller (243). For example, when the observer turns his or her head, the rotatable base (261) adjusts the position of the display assembly to keep the assembly directly facing the observer.

In one embodiment, the display assembly is moved together to keep the assembly facing the observer; and the orientations of the filter stripes are adjustable to change the distance between the sweet spots (201 and 203) to the filter strips. Thus, in combination, the sweep spots (201 and 203) can be adjusted to follow the tracked position of the observer. In one embodiment, the orientations of the filter stripes are adjusted to change the distance from the filter structure to the sweet spots (e.g., without changing the interocular distance or eye separation); and a guide structure is used to move the filter stripes in unison, actuated by one electromechanical element.

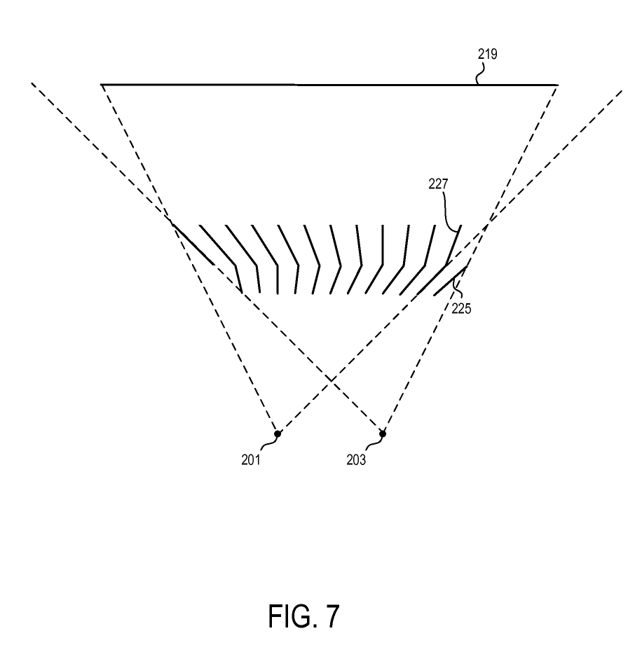

FIG. 7 illustrates an arrangement where the filter strips are connected at some edges of neighboring strips and disconnected at some other edges. In FIG. 7, filter strips (e.g., 225) that are parallel to the viewing directions from the left position (201) are arranged in front of the filter strips (e.g., 227) that are parallel to the viewing directions from the right position (203). Alternatively, the strips filtering for the left position (201) can be arranged in front of the strips filtering for the right position (203). The filter strips can generally be arranged in a multiple-layer configuration.

In one embodiment, the filter structure is adjustable to accommodate the change in position and orientation of the observer. For example, the filter strips can be manually adjusted, such as by pulling or pushing the structure as a whole or rotating the individual filter strips to change the designed sweet spots. For example, the strips can be individually or collectively coupled with one or more motors or drivers to adjust the angle between the strips, based on manual or automatic control. For example, a microprocessor or a computer can be used to compute the desired sweet spots and, via or as part of a suitable position controller, adjust the strips to the desired locations accordingly. In one embodiment, the eyes of an observer are tracked (e.g., using a known tracking camera set) so that the control system can determine the desired viewing positions and adjust the orientations of the strips accordingly to cause the sweet spots to follow the position of the viewer's eyes.

The filter structure 103 can be moved as a whole to track the position and orientation of the observer. Further, the screen 101 can be moved together with the filter structure. For example, the assembly of the filter layer and the display screen can be moved to keep the pre-designed position and orientation relative to the observer such that the sweet spots associated with the filter layer coincide with the eyes of the observer.

For example, the filter layer and the screen can be mounted on a rotatable base (261). When the observer moves, the rotatable base moves accordingly to keep the filter layer and the screen facing the user directly. The rotation of the screen and/or the filter structure can be automatic, according to the tracked location of the viewer relative to the screen and the filter layer, or can be manual, according to various embodiments.

Optionally, other embodiments additionally includes one or more eye-tracking cameras (257), which can be mounted on the screen or the filter structure or elsewhere. Such eye-tracking cameras can detect the movement of the eyes of the observer, which detection can be used to automatically control the rotation of the display assembly (e.g., via the rotating base or adjustment of the filter strips) to maintain a pre-designed orientation of the display assembly or filter position relative to the observer.

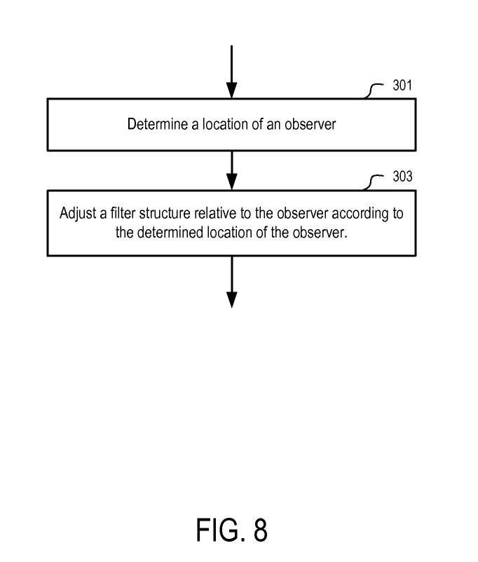

FIG. 8 illustrates a method to control the arrangement of a filter structure according to one embodiment. In FIG. 8, a location of an observer is determined (301). The location of the observer can be determined using a location tracking system, such as a camera based tracking system, or radio or other electro-magnetic signal, or ultrasound, laser based tracking system, or any other tracking system now known or to become known. A filter structure relative to the observer according to the determined location of the observer is then adjusted (303). In one embodiment, the filter structure includes multiple filter strips which can be individually adjusted to keep one set of the filter strips parallel to the viewing direction from the left eye of the observer and another set of the filter strips parallel to the viewing direction from the right eye of the observer. Thus, the left eye of the observer sees the image that is displayed behind the filter structure through one set of filter strips; and the right eye of the observer through another set of filter strips. The two different set of filter strips can be configured to have different characteristics (e.g., transparence, polarity, color) to cause the eyes of the observer to see left and right images of stereograph display respectively.

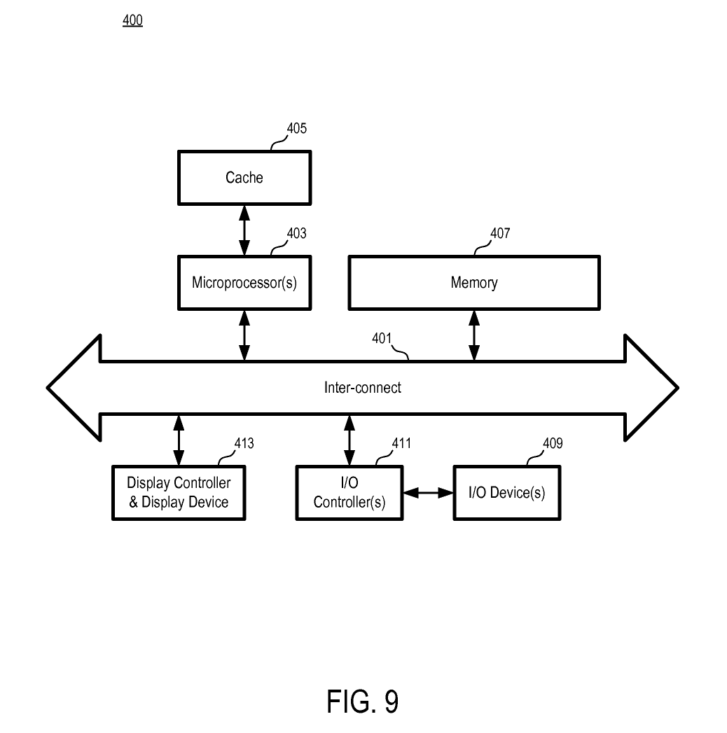

FIG. 9 shows a block diagram example of a data processing system for controlling the arrangement of a filter structure according to one embodiment.

While FIG. 9 illustrates various components of a computer system, it is not intended to represent any particular architecture or manner of interconnecting the components. Other systems that have fewer or more components can also be used.

In FIG. 9, the computer system (400) is a form of a data processing system. The system (400) includes an inter-connect (401) (e.g., bus and system core logic), which interconnects a microprocessor(s) (403) and memory (407). The microprocessor (403) is coupled to cache memory (405), which can be implemented on a same chip as the microprocessor (403).

The inter-connect (401) interconnects the microprocessor(s) (403) and the memory (407) together and also interconnects them to a display controller and display device (413) and to peripheral devices such as input/output (I/O) devices (409) through an input/output controller(s) (411). Typical I/O devices include mice, keyboards, modems, network interfaces, printers, scanners, video cameras and other devices.

The inter-connect (401) can include one or more buses connected to one another through various bridges, controllers and/or adapters. In one embodiment the I/O controller (411) includes a USB (Universal Serial Bus) adapter for controlling USB peripherals, and/or an IEEE-1394 bus adapter for controlling IEEE-1394 peripherals. The inter-connect (401) can include a network connection.

The memory (407) can include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The instructions to control the arrangement of a filter structure can be stored in memory (407) or obtained through an I/O device (e.g., 409). In one embodiment, the stereograph display is generated using the display controller and display device (413).

At least some embodiments can be implemented using hardware, programs of instruction, or combinations of hardware and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. An apparatus, comprising:
a filter layer including:
a first plurality of filter strips arranged in parallel with viewing directions from a first viewing position, and
a second plurality of filter strips arranged in parallel with viewing directions from a second viewing position.

2. The apparatus of claim 1, wherein the first and second viewing positions are configured to be in front of the filter layer for eyes of an observer.

3. The apparatus of claim 1, wherein the filter strips of the first and second pluralities are capable of being switched between transparent and opaque states.

4. The apparatus of claim 3, wherein when the first plurality of filter strips are opaque, the filter layer blocks a view to the second viewing position; when the second plurality of filter strips are opaque, the filter layer blocks a view to the first viewing position.

5. The apparatus of claim 4, wherein when the first plurality of filter strips are transparent, the filter layer unblocks a view to the second viewing position; when the second plurality of filter strips are transparent, the filter layer unblocks a view to the first viewing position.

6. The apparatus of claim 3, wherein each of the filter strips comprises a Liquid Crystal (LC) shutter strip.

7. The apparatus of claim 6, further comprising:
circuitry coupled to the filter strips to alternatively switch the first plurality of filter strips between transparent and opaque states and the second plurality of filter strips between opaque and transparent states.

8. The apparatus of claim 7, further comprising:
a display device coupled to the circuitry, the circuitry switching the filter strips in accordance with a refresh frequency of the display device.

9. The apparatus of claim 1, further comprising:
a positioning structure coupled to the filter layer to move the filter layer according to location tracking data.

10. The apparatus of claim 9, wherein the positioning structure comprises a rotatable base.

11. The apparatus of claim 1, wherein orientations of the filter strips are adjustable.

12. The apparatus of claim 11, further comprising:
an orientation adjustment structure coupled to the filter strips to adjust the orientations of the filter strips according to location tracking data of an observer.

13. The apparatus of claim 1, wherein the first plurality of filter strips filter light differently from the second plurality of filter strips based on an optical characteristic.

14. The apparatus of claim 13, wherein the optical characteristic comprises color or polarity or both.

15. A method, comprising:
determining a location of an observer positioned relative to a display device operable to display a stereo-optic image to be viewed through a filter structure; and
adjusting the filter structure relative to the observer according to the determined location of the observer.

16. The method of claim 15, wherein the filter structure comprises a first plurality of strips parallel with viewing directions from a first viewing position and a second plurality of strips parallel with viewing directions from a second viewing position.

17. The method of claim 16, wherein the strips are switchable between transparent and opaque states.

18. The method of claim 17, wherein the strips comprise Liquid Crystal (LC) shutter strips.

19. The method of claim 16, wherein said adjusting comprises:
adjusting the filter structure to cause sweet spots of the filter structure to follow tracked positions of eyes of the observer.

20. The method of claim 19, wherein said adjusting comprises:
adjusting orientations of the strips to cause the sweet spots of the filter structure to follow tracked positions of eyes of the observer.

21. A machine readable media embodying instructions, the instructions causing a machine to perform a method, the method comprising:
determining a location of an observer; and
generating a control signal to adjust a filter structure relative to the observer according to the determined location of the observer.

22. A data processing system, comprising:
means for determining a location of an observer; and
means for generating a control signal to adjust a filter structure relative to the observer according to the determined location of the observer.

23. A data processing system, comprising:
memory to store instructions;
a processor coupled to the memory and the port, the processor to execute the instructions to determine a location of an observer and to generate a control signal to adjust a filter structure relative to the observer according to the determined location of the observer.

24. A system, comprising:
a display device;
a shutter layer including a first plurality of Liquid Crystal (LC) shutter strips parallel with viewing directions from a first viewing position and a second plurality of LC shutter strips parallel with viewing directions from a second viewing position; and
a controller coupled to the display device and the shutter layer to selectively switch the LC strips between transparent and opaque states in synchronization with a refresh of images generated by the display device.

25. The system of claim 24, further comprising:
a location tracking system coupled to the controller to adjust the shutter layer to cause the viewing positions to follow tracked eye positions of an observer.

26. A stereographic viewing system, comprising:
a display for displaying an image to be viewed;
an eye tracker for tracking a viewing location of at least one eye of a viewer of the image;
a filter disposed between the viewer and the display for selectively permitting the display to be alternately viewed by one eye of the viewer and then another eye of the viewer; and
a positioning system connected to the tracker and the filter to adjust the filter relative to the viewer in response to a change in the viewing location.
